(19) United States
(12) Patent Application Publication
(10) Pub. No.: US 2009/0008957 A1
(43) Pub. Date: Jan. 8, 2009

(54) Top for a Convertible Vehicle

(76) Inventor: Markus Kaute, Renningen (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/885,507

(22) PCT Filed: Feb. 22, 2006
(86) PCT No.: PCT/EP06/01580

§ 371 Date: Sep. 9, 2008

(30) Foreign Application Priority Data
Mar. 3, 2005 (DE) 10 2005 009 720.0

(51) Int. Cl. B60J 7/00

(52) U.S. Cl. 296/107.01

(57) ABSTRACT

A top (1) for a convertible vehicle has at least one roof part (3) which is movable between a closed and an open position, and, in its open position, is put away in a trunk (6) of the convertible vehicle, and a movably mounted, planar covering element (8), the rear edge (9) of which, in the open position of the roof part (3), bears against a trunk lid (7) and, together with the same, closes the trunk (6). In the closed position of the at least one roof part (3), at least the rear edge (9) of the covering element (8) comes to lie below the roof part (3).

The invention relates to a top for a convertible vehicle, with at least one roof part which is movable between a closed and an open position, in accordance with the type defined in more detail in the precharacterizing clause of claim 1. The invention furthermore relates to a convertible vehicle.

DE 101 17 767 C2 discloses a rear covering for a convertible, which, in a first position, covers the top-receiving compartment when the top is closed and, in a second position, covers it when the top is open. In the open position of the top, the covering element forms part of the outer skin of the vehicle, whereas, in the closed position of the top, it is located within the vehicle. Owing to the fact that, in the open position of the top, the covering ends with the trunk flap, but, in the closed position of the top, it ends with a rear section of the top or the rear roof part, two different positions of the covering arise. As a result, the covering element has to span a greater length in the open position of the top than in the closed position, in which the roof part is located between the trunk lid and the covering element. This problem is solved, according to DE 101 17 767 C2, in that the covering is displaced into the rear region of the vehicle.

However, this results in space problems in the rear and therefore cannot be used in the majority of vehicles. In addition, the driving kinematics used for moving said covering is extremely complicated and has a plurality of multi-joint hinges arranged consecutively. The complexity of said driving kinematics is further increased by the latter having to be locked in both closed positions of the covering in order to prevent a movement of the covering.

In other solutions known from the general prior art, it is endeavored to bypass this problem by the covering element having, in its rear region, a compensating strip which is extended in the open or put-away position of the top and therefore spans the greater length. However, a structure of this type is associated with the disadvantage that additional drives and control elements are required for the compensating strip. Furthermore, the compensating strip and the gap present between the covering element and the compensating strip interfere with the design of the convertible vehicle.

It is therefore the object of the present invention to provide a top for a convertible vehicle, in which a covering element which upwardly closes the trunk is designed as a single part and is nevertheless capable of covering the different lengths which arise in the closed position and in the open position of the top and which are to be spanned, with the need for additional space being avoided as far as possible.

According to the invention, this object is achieved by the features mentioned in claim 1.

Owing to the fact that, in the closed position of the roof part, at least the rear edge of the covering element comes to lie below the same, the covering element can very easily be put away in the closed state of the top, in which the top interferes with the positioning of the covering element. As a result, the excessive length of the covering element in the closed position of the top is insignificant, and, in both positions of the top, secure closure of the trunk in the upward direction is ensured by the covering element.

An additional compensating strip is advantageously not required for the covering element, and therefore driving and control elements necessary for this purpose can be omitted, and also a gap which interferes with the design of the vehicle in this region does not arise nor is there a loss of construction space in the rear of the vehicle, since the excess length of the covering element is simply arranged below the roof part where it does not constitute a disturbance.

A convertible vehicle with a top according to the invention is provided in claim 10.

Advantageous refinements and developments of the invention emerge from the subclaims. An exemplary embodiment of the invention is illustrated schematically below with reference to the drawing, in which:

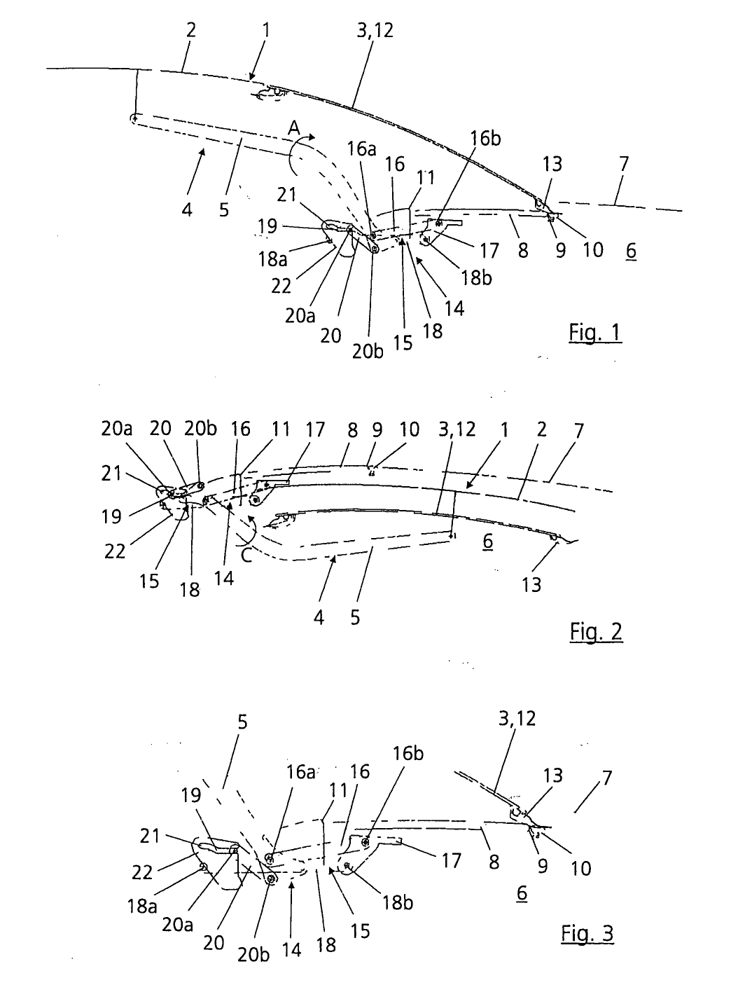

FIG. 1 shows a section through a top according to the invention in its closed state;

FIG. 2 shows the top from FIG. 1 in its open or put-away state;

FIG. 3 shows an enlarged illustration of a driving kinematics for a covering element of the top according to the invention in that position of the same according to FIG. 1;

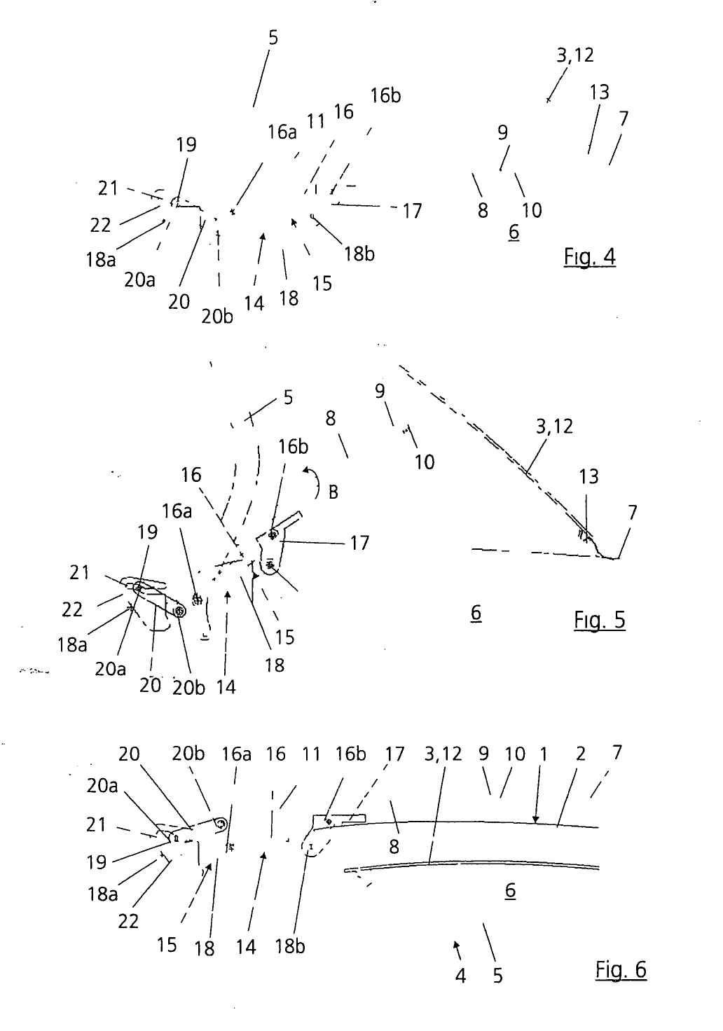

FIG. 4 shows the driving kinematics with the covering element from FIG. 3 in a first intermediate position;

FIG. 5 shows the driving kinematics with the covering element from FIG. 3 in a second intermediate position;

FIG. 6 shows the driving kinematics with the covering element from FIG. 3 in the position of the top according to FIG. 2;

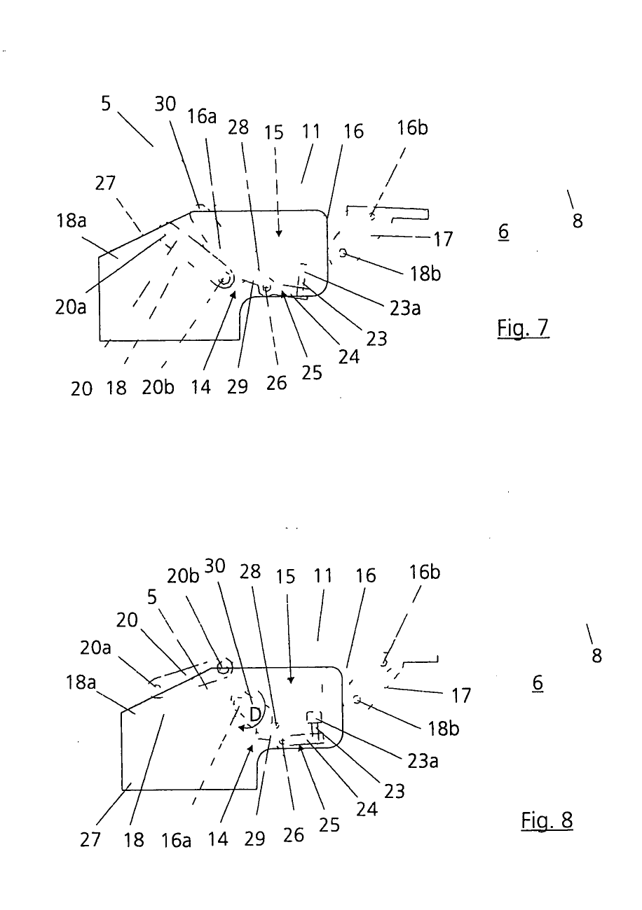

FIG. 7 shows the driving kinematics with a movable stop in the position according to FIG. 3; and

FIG. 8 shows the driving kinematics from FIG. 7 in the position according to FIG. 6.

FIG. 1 shows a top 1 for a convertible vehicle which is not illustrated in its entirety. The top 1, which, in the present case, is designed as a hard top known per se, has two fixed roof parts, namely a front roof part 2 and a rear roof part 3. The two roof parts 2 and 3 can be brought by means of a top kinematics 4, of which only a main link 5 is illustrated in the present case, from the closed position, which is illustrated in FIG. 1 and in which the two roof parts 2 and 3 form a roof for the convertible vehicle, into a put-away or open position of the top 1, in which the top 1 is located in a top storage compartment or trunk 6 of the convertible vehicle 1. In order to reach this position, the main link 5 is rotated according to the arrow “A”, for which purpose use can be made of driving devices, such as, for example, one or more hydraulic or pneumatic cylinders or else one or more electrical motors.

The trunk 6 is upwardly closed both in the closed position and in the open position of the top 1 by means of a trunk lid 7 which is movable in a manner known per se. The trunk lid 7 comes to lie in the same position in the closed position and in the open position of the top 1. In order, in the closed state of the top 1, also to close off the trunk 6 in relation to the interior of the convertible vehicle and, in the open state of the top 1, to achieve complete covering of the trunk 6, a covering element 8, which is also referred to as a rear parcel shelf, is provided. The covering element 8, as described in more detail at a later time, is coupled to the top kinematics 4 and is movable between two positions closing the trunk 6.

The length of the covering element 8 that is necessary for the complete covering of the trunk 6 is determined by the open position of the top 1, since a greater length has to be spanned here than in the closed position of the top 1, in which the roof part 3 is arranged between the trunk lid 7 and the covering element 8. In the open position of the top 1, a sealing element 10 fitted to a rear edge 9 of the covering element 8 bears against the trunk lid 7, as a result of which it is ensured that the trunk 6 is always well sealed. On the side opposite the rear edge 9 of the covering element 8, the covering element 8 is at a relatively small distance from a rear edge 11 of the vehicle rear. In the closed position of the top 1, said distance is essentially identical but, in this case, the covering element 8 cannot assume the position illustrated in FIG. 2, since the rear roof part 3 bears here against the sealing element 10 assigned to the covering element 8. For this reason, in the closed position of the two roof parts 2 and 3, which position is illustrated in FIG. 1, at least the rear edge 9 of the covering element 8 is arranged below the rear roof part 3 or comes to lie below the rear roof part 3. In the present case, the sealing element 10 of the covering element 8 also comes to lie below the rear roof part 3. In the present exemplary embodiment, the rear roof part 3 has a further seal (not visible) which, in the position shown in FIG. 1, is adjacent to the rear lid. In comparison to the open position of the top 1, the covering element 8 is slightly inclined in this position, i.e. the rear edge 9 is located at a lower level. The rear roof part 3 has a rear window 12 which is provided with a sealing element 13 against which the sealing element 10 of the covering element 8 bears in this position. In the open state of the top 1, the rear edge 9 of the covering element 8 therefore assumes the same position which is assumed by the sealing element 13 of the rear window 12 in the closed state of the top 1. In this case, the trunk lid 7 may also have a sealing element at its front end.

In this connection, it should be explained that the rear window 12 can be pivoted in relation to C-pillars (not illustrated) of the rear roof part 3 and therefore come to lie in the trunk 6 in the opposite direction to the C-pillars and in the same direction to the front roof part 2. One possibility for achieving such pivoting of the rear window 12 in relation to the C-pillars of the front roof part 2 is described in DE 101 37 023 C2 and will therefore not be explained in more detail below.

FIGS. 3 to 6 illustrate a driving kinematics 14 with which the covering element 8 can be raised in order to permit free travel for the two roof parts 2 and 3 and, in particular, for the rear window 12 during the movement of the top 1 between the closed and the open position. The driving kinematics 14, which is driven by the top kinematics 4 via the main link 5 acting as a driving link, and is therefore positively controlled, has a four-bar linkage 15. The four-bar linkage 15 comprises an upper link 16 which is connected in an articulated manner at its one end 16a to the bodywork or to a part of the convertible vehicle that is fixed on the bodywork. At the end 16b opposite the end 16a fixed on the bodywork, the upper link 16 is fitted in an articulated manner to a bracket 17 which is connected to the covering element 8 by means of screws (not illustrated) or other suitable connecting elements. The four-bar linkage 15 furthermore has a lower link 18 which is likewise mounted in an articulated manner at one end 18a fixed on the bodywork and, at an end 18b lying opposite the end 18a, is fitted to the bracket 17 in an articulated manner.

In the region of its end 18a fixed on the bodywork, the lower link 18 has a claw 19 which is provided for the purpose of entering into engagement with a bolt 20a fitted to a connecting link 20. At its end 20b lying opposite the bolt 20a, the connecting link 20 is fitted in an articulated manner to the main link 5 and therefore produces the connection (briefly indicated above) of the main link 5 or of the top kinematics 4 to the driving kinematics 14 for the covering element 8. For this purpose, the bolt 20a is guided in a slotted guide 21 of an element 22 fixed on the bodywork and moves in the same when the main link 5 is rotated according to the arrow “A” during the putting-away movement of the top 1. However, in the position illustrated in FIG. 3, the bolt 20a is at a distance from the claw 19, which results in the movement of the main link 5 leading to a movement of the lower link 18 and therefore of the covering element 8 after a delay.

FIG. 4 illustrates the same position in which the bolt 20a enters into engagement with the claw 19 of the lower link 18. In this case, it can be seen that the rear window 12 has already covered a certain distance up to said engagement. The distance of the bolt 20a from the claw 19 in the closed position of the top 1 therefore leads to freewheeling of the covering element 8. The freewheeling for the bolt 20a at the start of the putting-away movement of the top 1 therefore causes the covering element 8 to remain in its position at the start of the putting-away movement of the top 1 until the rear window 12 has moved out of the pivoting region of the covering element 8 and therefore ensures a collision-free sequence between the covering element 8 and the rear window 12. The length of the freewheeling is determined by the distance of the bolt 20a from the claw 19 in the closed position of the top 1.

However, as soon as the bolt 20a has engaged in the claw 19, the covering element 8 is moved in accordance with the arrow “B” in FIG. 5, since the connecting link 20 rotates the lower link 18 about its end 18a which is fixed on the bodywork and which thereby presses the covering element 8 upward. The upper link 16 guides the covering element 8 during this rotational movement. The slotted guide 21 locks the bolt 20a in the claw 19 during the entire movement, thus resulting in positive guidance of the lower link 18. As a result, the covering element 8 is likewise positively guided and cannot drop downwards due to gravity.

The position of the covering element 8 furthest away from the horizontal position of the same, namely the orientation of the covering element 8 in the vertical direction, is not illustrated in the figures. In this vertical position of the covering element 8, in which the greatest possible free travel for the roof parts 2 and 3 and the rear window 12 is provided, the bolt 20a stops at least approximately against the end of the slotted guide 21.

FIG. 6 shows the completely put-away position of the top 1, in which the two roof parts 2 and 3 are located in the trunk 6. It can be seen in this case that the rear window 12 is put away in the same direction as the front roof part 2. However, the storage of the rear window 12 in the opposite direction to the C-pillars cannot be seen, since the C-pillars are not illustrated.

If the top 1 is to be brought from its open position into its closed position, it is required to rotate the main link 5 in accordance with the arrow “C” in FIG. 2. In this closed position, as can be seen in FIG. 6, there is no free travel for the bolt 20a in relation to the claw 19, since the covering element 8 is to be folded upward immediately at the beginning of the closing movement of the top 1 in order to be able to move the front roof part 2 and the rear window 12 out of the trunk 6.

As is customary in the case of tops 1 of this type, both the top kinematics 4 and the driving kinematics 14 are arranged on both sides of the convertible vehicle, as viewed in the transverse direction of the same, in order to prevent distortion of the top 1. However, for reasons of clarity and better illustration, only one side of the top kinematics 4 and of the driving kinematics 14 is illustrated in each case.

In order to support the covering element 8 in both positions, in which the same upwardly closes the trunk 6, a stop element 23 is provided which is fitted on a first arm 24 of a tilting lever 25 which is mounted rotatably about a pivot point 26. In this case, the pivot point 26 of the tilting lever 25 is located on a main bearing 27, which also constitutes the abovementioned component which is fixed on the bodywork and to which the upper link 16 and the lower link 18 are fitted in an articulated manner. In the position of the covering element 8 that is illustrated in FIG. 7 and corresponds to the closed position of the top 1, the lower link 18 bears against the stop element 23 which has a buffer 23a which serves for damping and is composed of a flexible material, such as, for example, rubber. In order to limit the movement of the lower link 18, a stop 28 is provided which, in the present case, is fitted rigidly to the main bearing 27 and against which a second arm 29 of the tilting lever 25, which arm lies opposite the first arm 24, bears or stops.

Since the covering element 8 in the position according to FIG. 8 is to come to lie in a higher position than that according to FIG. 7, as has been described in detail above, a control link 30 fitted to the main link 5 moves the tilting lever 25 in accordance with the arrow “D” by applying a force to the second arm 29. The tilting lever 25 thereby rotates about the pivot point 26, as a result of which the second arm 29 is removed from the stop 28 and the stop element 23 which is fitted to the first arm 24 on the other side of the pivot point 26 comes to lie in a higher position than that according to FIG. 7. Accordingly, in the second end position of the covering element 8, the lower link 18 of the driving kinematics 14 in turn comes to lie against the stop element 23, but in a raised position.

If appropriate, it would also be possible for the covering element 8 itself or for another component involved in the movement of the covering element 8, such as, for example, the bracket 17 of the upper link 16, to bear against the stop element 23.

1-11. (canceled)

12. A top for a convertible vehicle, comprising:
at least one roof part which is movable between closed and open positions, and which, in its open position, is stowed in a trunk of the convertible vehicle; and
a movably mounted, planar covering element, a rear edge of which, in the open position of the roof part, bears against a trunk lid and, cooperates with the trunk lid to close the trunk; wherein,
in the closed position of the at least one roof part, at least the rear edge of the covering element lies below the roof part.

13. The top as claimed in claim 12, wherein, in the closed position of the roof part, the covering element bears against a rear window of the roof part.

14. The top as claimed in claim 13, wherein, in the closed position of the roof part, the covering element bears against a sealing element (13) of the rear window.

15. The top as claimed in claim 12, wherein the covering element has a sealing element which, in the open position of the roof part, bears against the trunk lid.

16. The top as claimed in claim 12, wherein the covering element can be driven by a top kinematics which drives the at least one roof part.

17. The top as claimed in claim 16, wherein the covering element is connected to a link of the top kinematics via at least one connecting link.

18. The top as claimed in claim 17, wherein the at least one connecting link connected to the covering element is guided in a slotted guide configured such that, at the beginning of movement of the at least one roof part from its closed into its open position, the covering element achieves a freewheeling movement.

19. The top as claimed in claim 18, wherein the connecting link is associated with bolt which is locked by the slotted guide during the entire movement of the covering element.

20. The top as claimed in claim 12, wherein:
a stop element is fitted to a first arm of a tilting lever;
the tilting lever mounted rotatably about a pivot point;
one of the covering element and a link of the driving kinematics of the covering element bears against said stop element in a first end position of the covering element;
in the first end position of the covering element, a second arm provided on the other side of the first arm of the tilting lever bears against a rigid stop, with a driving link of the top kinematics;
in a second end position of the covering element, the second arm brings the stop element, by exerting pressure on the second arm, into a position which is raised in relation to the first end position; and
the covering element or the link of the driving kinematics bears against the stop element in the second end position.

21. The top as claimed in claim 19, wherein the driving link has a control link for actuating the second arm of the tilting lever.

22. A convertible vehicle with a top as claimed in claim 1.
